(19) United States
(12) Patent Application Publication
(10) Pub. No.: US 2025/0266595 A1
(43) Pub. Date: Aug. 21, 2025

(54) METHOD OF MANUFACTURING ELECTRICITY STORAGE DEVICE AND ELECTRICITY STORAGE DEVICE

(71) Applicant: TOYOTA JIDOSHA KABUSHIKI KAISHA, Toyota-shi (JP)

(72) Inventors: Takeru HARA, Toyota-shi (JP); Shinji SUZUKI, Kariya-shi (JP)

(73) Assignee: TOYOTA JIDOSHA KABUSHIKI KAISHA, Toyota-shi (JP)

(21) Appl. No.: 18/930,729

(22) Filed: Oct. 29, 2024

(30) Foreign Application Priority Data
Feb. 21, 2024 (JP) 2024-025004

(51) Int. Cl. H01M 50/636

(52) U.S. Cl. CPC H01M 50/636

(57) ABSTRACT

In a method of manufacturing an electricity storage device, after an electrolyte solution is injected into an internal space through a liquid injection port of a liquid injection port member, a welding portion of a lid member is inserted into a liquid injection port frame of the liquid injection port member, and heating is performed from a support substrate side of the lid member such that the welding portion and an inner wall of the liquid injection port frame are welded and the liquid injection port is sealed. The inner wall of the liquid injection port frame is configured of a resin L, a part other than the inner wall of the liquid injection port frame is configured of a resin H, at least an outer peripheral surface of the welding portion is configured of a resin S, and the support substrate is configured of a material M.

### CROSS-REFERENCE TO RELATED APPLICATION

This application claims priority to Japanese Patent Application No. 2024-025004 filed on Feb. 21, 2024, incorporated herein by reference in its entirety.

### BACKGROUND

### 1. Technical Field

The present disclosure relates to a method of manufacturing an electricity storage device, and an electricity storage device.

### 2. Description of Related Art

There is known an electricity storage module including an electrode stack including a plurality of electrodes being stacked through intermediation of a separator, a case that holds the electrode stack, and an electrolyte solution accommodated between adjacent electrodes of the electrode stack. In such an electricity storage module, after the electrolyte solution is injected into an accommodating space of the electrode stack through a liquid injection port provided in the case that accommodates the electrode stack, a sealing member is attached to the liquid injection port to seal the electricity storage module (for example, see Japanese Unexamined Patent Application Publication No. 2020-173921).

### SUMMARY

As the sealing method performed after the electrolyte solution is injected from the liquid injection port, there is a method of obtaining a hermetically-sealed state by providing a liquid injection port frame around the liquid injection port and sealing the liquid injection port frame by a laminate or the like.

FIG. 6 illustrates an example of a method of sealing a liquid injection port 102. A liquid injection port frame 104 is made of a resin. When such a liquid injection port frame 104 made of a resin is sealed by a laminate 140 after an electrolyte solution is injected from the liquid injection port 102, there is known a method of performing, as illustrated in FIG. 6, thermal welding by pressing a hot plate 130 in a state in which the laminate 140 is brought into contact with the liquid injection port frame 104. In this case, an end portion of the liquid injection port frame 104 may melt to be pushed into an electrode stack 118 side. In this case, a volume of a region surrounded by the liquid injection port frame 104 and the laminate 140 is reduced by, for example, ΔV, and the internal pressure of the region is increased. The increase of the internal pressure causes a gas present in the region surrounded by the liquid injection port frame 104 and the laminate 140 to try to escape to the outside, and thus a hole may be formed in the welded part, resulting in reduction of the hermeticity of the electricity storage module.

The present disclosure has an object to provide a method of manufacturing an electricity storage device that can seal a liquid injection port with high hermeticity after an electrolyte solution is injected from the liquid injection port, and an electricity storage device having high hermeticity of the liquid injection port.

Means for solving the above-mentioned problems includes the following aspects.

<1> A method of manufacturing an electricity storage device including: an electrode stack including a plurality of bipolar electrodes being stacked through intermediation of a separator; a sealing member that seals a peripheral edge portion of the electrode stack; and an electrolyte solution accommodated between the bipolar electrodes adjacent in a stacking direction in the electrode stack, the method including:
a liquid injecting step of injecting the electrolyte solution into an internal space between the adjacent bipolar electrodes through a liquid injection port of a liquid injection port member including the liquid injection port and a liquid injection port frame, the liquid injection port being provided for injecting the electrolyte solution into the internal space, the liquid injection port frame surrounding the liquid injection port; and
a sealing step of sealing the liquid injection port after the liquid injecting step, by inserting, into the liquid injection port frame of the liquid injection port member, a welding portion of a lid member including the welding portion having a shape along an inner wall of the liquid injection port frame and a support substrate that supports the welding portion, and performing heating from the support substrate side of the lid member such that the welding portion of the lid member and the inner wall of the liquid injection port frame are welded, in which
the liquid injection port member has the inner wall of the liquid injection port frame configured of a resin L, and a part other than the inner wall of the liquid injection port frame configured of a resin H,
the lid member has at least an outer peripheral surface of the welding portion configured of a resin S, and the support substrate configured of a material M, and
a melting point Tm or a glass transition temperature Tg of each of the resin L, the resin H, and the resin S, and a heating temperature in the sealing step satisfy the following conditions of a, b, and c:
a: the melting point Tm or the glass transition temperature Tg of the resin L is smaller than the melting point Tm or the glass transition temperature Tg of the resin H;
b: the melting point Tm or the glass transition temperature Tg of the resin S is smaller than the melting point Tm or the glass transition temperature Tg of the resin H; and
c: the heating temperature in the sealing step is equal to or larger than the melting point Tm or the glass transition temperature Tg of the resin L, is equal to or larger than the melting point Tm or the glass transition temperature Tg of the resin S, and is smaller than the melting point Tm or the glass transition temperature Tg of the resin H.

<2> The method of manufacturing an electricity storage device according to Item <1>, in which the resin H is polypropylene, and the resin L and the resin S are polyethylene.

<3> The method of manufacturing an electricity storage device according to Item <1> or <2>, in which the welding portion is configured to include a welding portion substrate, and a resin S layer configured of the resin S that covers the welding portion substrate.

<4> The method of manufacturing an electricity storage device according to any one of Items <1> to <3>, in which the electricity storage device has a rectangular shape as viewed in a thickness direction of the electricity storage device, and the rectangular shape has side lengths of 1,000 mm or more lengthwise and 10,000 mm or more crosswise.

<5> An electricity storage device, including: an electrode stack including a plurality of bipolar electrodes being stacked through intermediation of a separator; a sealing member that seals a peripheral edge portion of the electrode stack; and an electrolyte solution accommodated between the bipolar electrodes adjacent in a stacking direction in the electrode stack, the electricity storage device further including:
a liquid injection port member including a liquid injection port provided for injecting the electrolyte solution into an internal space between the adjacent bipolar electrodes and a liquid injection port frame that surrounds the liquid injection port; and
a lid member including a welding portion having a shape along an inner wall of the liquid injection port frame and a support substrate that supports the welding portion, the welding portion being welded to the inner wall of the liquid injection port frame, in which
the liquid injection port member has the inner wall of the liquid injection port frame configured of a resin L, and a part other than the inner wall of the liquid injection port frame configured of a resin H,
the lid member has at least an outer peripheral surface of the welding portion configured of a resin S, and the support substrate configured of a material M, and
a melting point Tm or a glass transition temperature Tg of each of the resin L, the resin H, and the resin S satisfies the following conditions of a and b:
a: the melting point Tm or the glass transition temperature Tg of the resin L is smaller than the melting point Tm or the glass transition temperature Tg of the resin H; and
b: the melting point Tm or the glass transition temperature Tg of the resin S is smaller than the melting point Tm or the glass transition temperature Tg of the resin H.

According to the present disclosure, the method of manufacturing an electricity storage device that can seal the liquid injection port with high hermeticity after the electrolyte solution is injected from the liquid injection port, and the electricity storage device having high hermeticity of the liquid injection port are provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating an example of an electricity storage device;

FIG. 2 is a schematic view illustrating a liquid injection port member and a lid member at one end portion of an electrode stack;

FIG. 3 is a schematic front view illustrating an example of a liquid injection port frame;

FIG. 4 is a schematic front view illustrating an example of the lid member;

FIG. 5 is a schematic configuration view illustrating a part of the lid member obtained by enlarging a dotted-line part A of FIG. 2; and

FIG. 6 is a schematic view illustrating an example of a method of sealing the liquid injection port frame with a laminate.

### DETAILED DESCRIPTION OF EMBODIMENTS

Hereinafter, with reference to the drawings, a method of manufacturing an 10 electricity storage device and an electricity storage device according to the present disclosure are described. In the drawings, the same or corresponding parts are denoted by the same reference symbols, and the symbols are omitted as appropriate in the same drawing.

In the present disclosure, the term “step” includes not only an independent step, but also a step that cannot be clearly distinguished from another step as long as the intended purpose of the step is achieved.

The method of manufacturing an electricity storage device according to the present disclosure is a method of manufacturing an electricity storage device including: an electrode stack including a plurality of bipolar electrodes being stacked through intermediation of a separator; a sealing member that seals a peripheral edge portion of the electrode stack; and an electrolyte solution accommodated between the bipolar electrodes adjacent in a stacking direction in the electrode stack.

The method of manufacturing an electricity storage device according to the present disclosure includes: a liquid injecting step of injecting the electrolyte solution into an internal space through a liquid injection port; and a sealing step of sealing the liquid injection port after the liquid injecting step.

In the liquid injecting step, the electrolyte solution is injected into the internal space through the liquid injection port of a liquid injection port member including the liquid injection port and a liquid injection port frame. The liquid injection port is provided for injecting the electrolyte solution into the internal space between the adjacent bipolar electrodes. The liquid injection port frame surrounds the liquid injection port.

In the sealing step, a welding portion of a lid member including the welding portion having a shape along an inner wall of the liquid injection port frame and a support substrate that supports the welding portion is inserted into the liquid injection port frame of the liquid injection port member, and heating is performed from the support substrate side of the lid member such that the welding portion of the lid member and the inner wall of the liquid injection port frame are welded and the liquid injection port is sealed.

The liquid injection port member has the inner wall of the liquid injection port frame configured of a resin L, and a part other than the inner wall of the liquid injection port frame configured of a resin H. The lid member has at least an outer peripheral surface of the welding portion configured of a resin S, and the support substrate configured of a material M.

In addition, a melting point Tm or a glass transition temperature Tg of each of the resin L, the resin H, and the resin S, and a heating temperature in the sealing step satisfy the following conditions of a, b, and c:
a: the melting point Tm or the glass transition temperature Tg of the resin L is smaller than the melting point Tm or the glass transition temperature Tg of the resin H;
b: the melting point Tm or the glass transition temperature Tg of the resin S is smaller than the melting point Tm or the glass transition temperature Tg of the resin H; and
c: the heating temperature in the sealing step is equal to or larger than the melting point Tm or the glass transition temperature Tg of the resin L, is equal to or larger than the melting point Tm or the glass transition temperature Tg of the resin S, and is smaller than the melting point Tm or the glass transition temperature Tg of the resin H.

Further, the electricity storage device according to the present disclosure includes: an electrode stack including a plurality of bipolar electrodes being stacked through intermediation of a separator; a sealing member that seals a peripheral edge portion of the electrode stack; and an electrolyte solution accommodated between the bipolar electrodes adjacent in a stacking direction in the electrode stack.

The electricity storage device according to the present disclosure further includes: a liquid injection port member including a liquid injection port provided for injecting the electrolyte solution into an internal space between the adjacent bipolar electrodes and a liquid injection port frame that surrounds the liquid injection port; and a lid member including a welding portion having a shape along an inner wall of the liquid injection port frame and a support substrate that supports the welding portion, the welding portion being welded to the inner wall of the liquid injection port frame.

The liquid injection port member has the inner wall of the liquid injection port frame configured of a resin L, and a part other than the inner wall of the liquid injection port frame configured of a resin H. The lid member has at least an outer peripheral surface of the welding portion configured of a resin S, and the support substrate configured of a material M.

In addition, a melting point Tm or a glass transition temperature Tg of each of the resin L, the resin H, and the resin S satisfies the above-mentioned conditions of a and b.

Hereinafter, an electricity storage device according to an embodiment of the present disclosure, and a configuration of an electricity storage device manufactured by a method of manufacturing an electricity storage device according to an embodiment of the present disclosure are described by means of examples. In the description of the drawings, the same or equivalent elements are denoted by the same reference symbols, and redundant description thereof is omitted as appropriate.

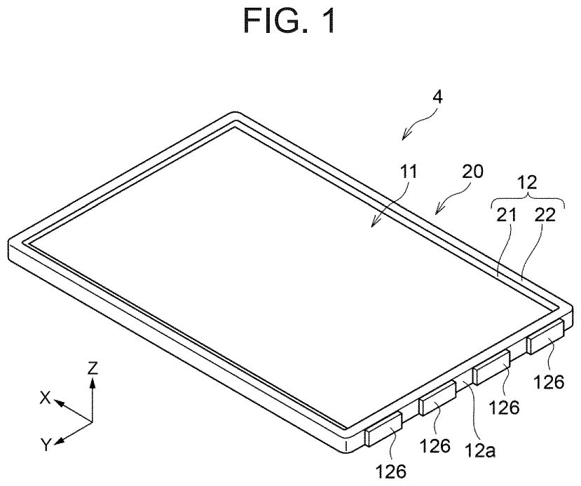

FIG. 1 is a schematic perspective view illustrating an example of the electricity storage device. A device main body 20 includes an electrode stack 11 and a sealing member 12 made of a resin that seals the electrode stack 11.

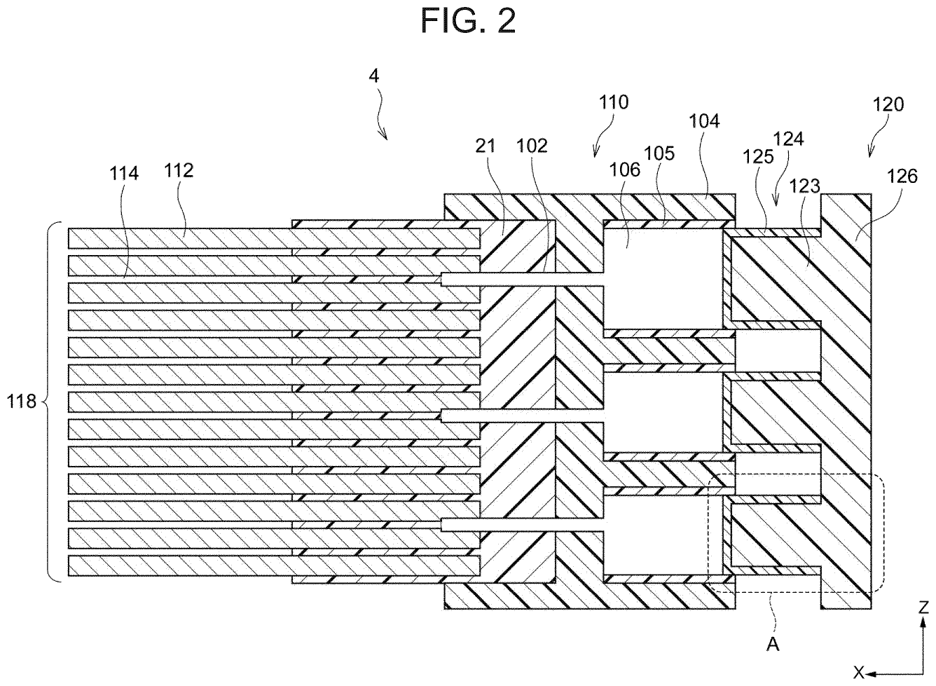

FIG. 2 is a schematic view illustrating a liquid injection port member and a lid member at one end portion of the electrode stack 11. FIG. 2 illustrates the electrode stack and the like in a simplified manner.

The electrode stack 118 includes a plurality of bipolar electrodes 112 (which is herein sometimes simply referred to as “electrode”) being stacked through intermediation of a separator (not shown). A peripheral edge portion of each bipolar electrode 112 is sealed by the sealing member 12. The electrode stack 118 may have a configuration including, for example, a stack of a plurality of bipolar electrodes, a negative electrode terminal electrode, and a positive electrode terminal electrode. An internal space 114 in which the electrolyte solution is accommodated is provided between the bipolar electrodes 112 adjacent in a stacking direction.

The electrode stack 118 has a rectangular shape as viewed in a thickness direction of the battery (that is, as viewed in the stacking direction in the electrode stack 118). The “rectangular shape” referred to here includes not only a case of an exact rectangular shape (for example, a rectangle, a square, or the like), but also a case of a shape close to the rectangular shape as the whole battery. Thus, the “rectangular shape” described above also include a shape close to a rectangular shape with slightly rounded corners, for example.

In addition, the battery having a rectangular shape can have side lengths in the rectangular shape of 1,000 mm or more lengthwise and 10,000 mm or more crosswise.

The sealing member 12 is formed in a rectangular tubular shape as a whole. The sealing member 12 is disposed on the side surface of the electrode stack 118. The sealing member 12 includes primary seal materials 21 to be welded to upper and lower end portions of a laminated foil obtained by bonding Al and Cu via an adhesive layer, and a secondary seal material 22 that seals an inside and an outside of a battery cell by being welded to an end portion of each of the primary seal materials 21 and an end portion of a spacer disposed between the primary seal materials 21.

The primary seal material 21 is, for example, a resin film having a predetermined thickness in the stacking direction.

The secondary seal material 22 is provided on the outer side of the electrode stack 11 and the primary seal material 21, and configures an outer wall (a casing) of an electricity storage device 4. The secondary seal material 22 extends across the entire length of the electrode stack 118 along the stacking direction. The secondary seal material 22 has a rectangular frame shape. The secondary seal material 22 is welded to, for example, an outer surface of the primary seal material 21.

The primary seal material 21 and the secondary seal material 22 form an internal space between the adjacent electrodes in the electrode stack 11 and seal the internal space 114. In the internal space 114, for example, an electrolyte solution (not shown) including a non-aqueous solvent to be described later and an electrolyte salt dissolved in the non-aqueous solvent is accommodated. For example, the separator, a positive electrode, and a negative electrode that configure the electrode stack 11 are impregnated with the electrolyte solution.

On a wall portion 12a on one side configuring the sealing member 12, a liquid injection port member 110 including the liquid injection port 102 and the liquid injection port frame 104 that surrounds the liquid injection port 102 is provided. That is, the liquid injection port member 110 configures a part of the secondary seal material 22. The electrolyte solution is injected into the internal space 114 through the liquid injection port 102.

### Liquid Injection Port Member

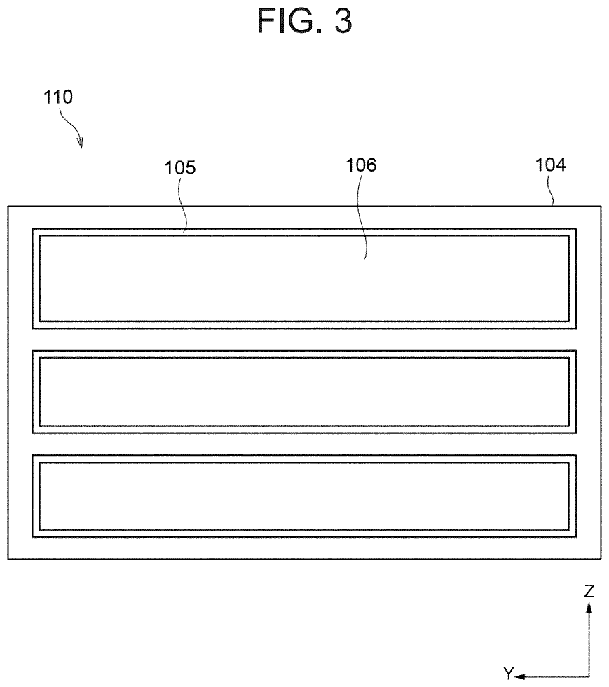

FIG. 3 is a schematic front view illustrating an example of the liquid injection port frame. The liquid injection port member 110 includes the liquid injection port 102 provided for injecting the electrolyte solution, and the liquid injection port frame 104 that surrounds the liquid injection port 102.

The liquid injection port 102 is formed across the primary seal material 21 and the secondary seal material 22 (the liquid injection port member 110), and is communicated with the internal space 114. When the electrolyte solution is injected from the liquid injection port 102, the electrolyte solution is supplied to the internal space 114 between the bipolar electrodes 112 adjacent in the stacking direction. The liquid injection port frame 104 has an inner wall 105 configured of a resin L, and a part other than the inner wall 105 of the liquid injection port frame 104 configured of a resin H.

It is to be noted that FIG. 2 illustrates three liquid injection ports 102, but the liquid injection port 102 is provided for each internal space 114 of the adjacent bipolar electrodes 112. Specifically, eight liquid injection ports which are not shown and the liquid injection port frame corresponding to the eight liquid injection ports are provided at positions different from the illustrated liquid injection ports 102 and the like.

### Lid Member

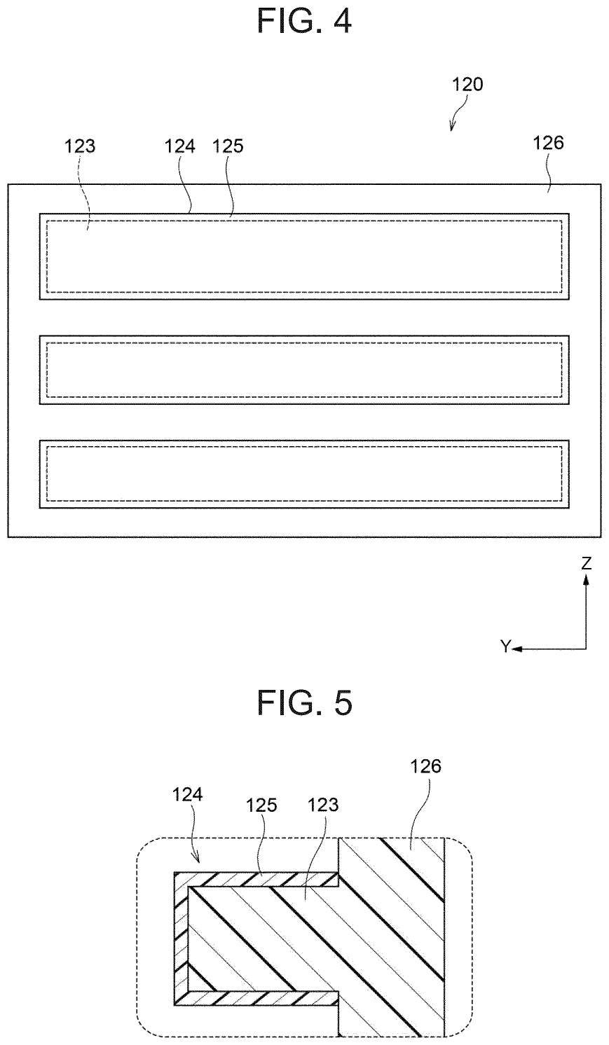

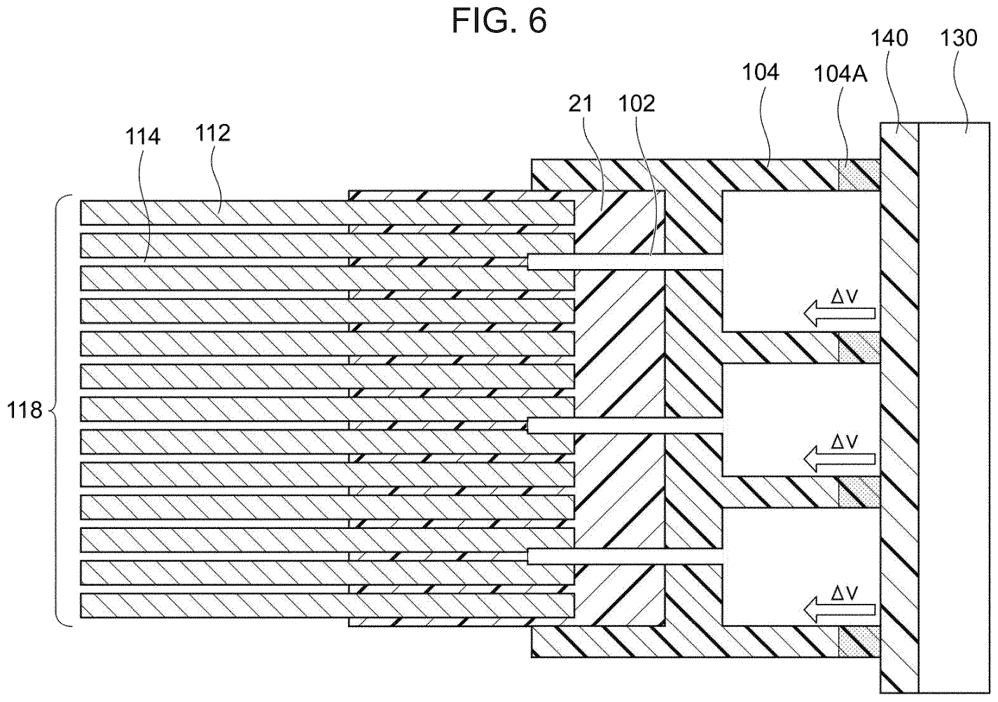

FIG. 4 is a schematic front view illustrating an example of a lid member 120. FIG. 5 is a schematic configuration view illustrating a part of the lid member obtained by enlarging a dotted-line part A of FIG. 2. The lid member 120 includes a welding portion 124 having a shape along the inner wall of the liquid injection port frame, and a support substrate 126 that supports the welding portion 124. As illustrated in FIG. 5, the welding portion 124 is configured of a welding portion substrate 123, and a resin S layer 125 configured of a resin S that covers the welding portion substrate 123.

The length of the welding portion 124 is only required to be equal to or smaller than the length of an insertion portion 106 of the liquid injection port frame 104 of the liquid injection port member 110.

The support substrate 126 is configured of a material M. In the sealing step, heating is performed from the support substrate 126 side, and hence examples of the material M configuring the support substrate 126 include materials having a heat resistance higher than the resin S, such as a metal, ceramics, and a resin.

The welding portion substrate 123 is also preferably configured of the material M similarly to the support substrate 126 integrally with the support substrate 126. The welding portion substrate 123 and the support substrate 126 of the lid member 120 are particularly preferably configured of a resin having a melting point Tm or a glass transition temperature Tg higher than the resin S.

The method of manufacturing an electricity storage device according to the present disclosure includes a liquid injecting step of injecting, with use of the liquid injection port member 110 and the lid member 120 as described above, the electrolyte solution into the internal space of the electrode stack from the liquid injection port surrounded by the liquid injection port frame, and a sealing step of sealing the liquid injection port after the liquid injecting step.

### Liquid Injecting Step

In the liquid injecting step, for example, a liquid injection connector (not shown) is connected to the liquid injection port frame 104 of the liquid injection port member 110. The liquid injection connector is connected to a tank (not shown) accommodating the electrolyte solution, and can send the electrolyte solution by a pump (not shown). The electrolyte solution is injected into the internal space 114 through the liquid injection port 102 via the liquid injection connector connected to the liquid injection port frame 104.

### Sealing Step

After the liquid injecting step, as illustrated in FIG. 2, in the x direction, the welding portion 124 of the lid member 120 is inserted into the insertion portion 106 in the liquid injection port frame 104 of the liquid injection port member 110.

After the insertion, heating is performed by pressing a heating pressure member against the lid member 120 from the support substrate 126 side of the lid member 120 such that the welding portion 124 of the lid member 120 is welded to the inner wall of the liquid injection port frame 104 and the liquid injection port 102 is sealed. For example, the heating is preferably performed from the support substrate 126 side of the lid member 120 by thermal pressing using a plate-shaped heating member (a hot plate).

It is to be noted that, from the viewpoint of reliably welding the welding portion 124 of the lid member 120 and the inner wall of the liquid injection port frame 104, a gap between the inner wall 105 of the liquid injection port frame 104 of the liquid injection port member 110 and an outer peripheral surface (a surface of the resin S layer) of the welding portion of the lid member 120 is preferably narrower than “the thickness of the resin S layer”×20%. The gap is preferably set to such a range because the coefficient of expansion at the time of heating of PE is about 20%.

Here, when the heating temperature obtained by the thermal pressing is excessively low, the welding portion 124 of the lid member 120 and the inner wall 105 of the liquid injection port frame 104 are not welded, and when the heating temperature is excessively high, a part other than the inner wall 105 of the liquid injection port frame 104 may melt. In view of the foregoing, in the method of manufacturing an electricity storage device according to the present disclosure, a melting point Tm or a glass transition temperature Tg of each of the resin L, the resin H, and the resin S and a heating temperature in the sealing step are set so as to satisfy the following conditions of a, b, and c:
a: the melting point Tm or the glass transition temperature Tg of the resin L is smaller than the melting point Tm or the glass transition temperature Tg of the resin H;
b: the melting point Tm or the glass transition temperature Tg of the resin S is smaller than the melting point Tm or the glass transition temperature Tg of the resin H; and
c: the heating temperature in the sealing step is equal to or larger than the melting point Tm or the glass transition temperature Tg of the resin L, is equal to or larger than the melting point Tm or the glass transition temperature Tg of the resin S, and is smaller than the melting point Tm or the glass transition temperature Tg of the resin H.

### Resin H, Resin L, Resin S, and Substrate

Description is given of an example of materials used in the resin L configuring the inner wall of the liquid injection port frame and the resin H configuring the part other than the inner wall of the liquid injection port frame in the liquid injection port member, and the resin S configuring the outer peripheral surface of the welding portion and the material M of the welding portion substrate in the lid member.

As a combination of the resin H, the resin L, the resin S, and the material M, for example, the following combination pattern can be given.
Combination Pattern 1

### Resin L: Polyethylene (PE, Tm=130° C.)

### Resin S: PE (Tm=130° C.)

### Resin H: Polypropylene (PP, Tm=160° C.)

### Substrate M: PP (Tm=160° C.)

In this case, in a method of manufacturing an electricity storage device according to an embodiment of the present disclosure, the thermal pressing in the sealing step is performed at a temperature of 130° C. or more and less than 160° C., and the temperature is preferably set to be higher than the melting point Tm of the resins L, S by 10° C. to 20° C. and lower than the melting point Tm of the resin H by 20° C. to 30° C.

Further, the following combination patterns are also preferred as the resin H, the resin L, and the resin S.
Combination Pattern 2

### Resin L: PE (Tm=130° C.)

### Resin S: PE (Tm=130° C.)

Resin H: Modified polyphenylene ether resin (Modified PPE resin, Tg=210° C.)
Substrate M: Modified PPE resin (Tg=210° C.)
Combination Pattern 3

### Resin L: PP (Tm=160° C.)

### Resin S: PP (Tm=160° C.)

Resin H: Modified PPE resin (Tg=210° C.)
Substrate M: Modified PPE resin (Tg=210° C.)

As the resin L and the resin S, resins having the same melting point Tm or glass transition temperature Tg are preferably used, and as the resin H and the substrate material, resins having the melting points Tm or the glass transition temperatures Tg higher than those of the resin L and the resin S are preferably used.

As described above, after the liquid injecting step, the welding portion 124 of the lid member 120 and the inner wall of the liquid injection port frame 104 are welded by the sealing step. Thus, high hermeticity of the space inside of the liquid injection port frame communicated with the liquid injection port can be obtained.

Next, description is given of an electricity storage device according to an embodiment of the present disclosure, and materials and the like of members other than the liquid injection port member and the lid member configuring an electricity storage device manufactured by a method of manufacturing an electricity storage device according to an embodiment of the present disclosure.

### Positive Electrode Mixture Layer

The electrode includes a positive electrode mixture layer.

The positive electrode mixture layer includes a positive electrode active material, and may further include, for example, a binder.

Examples of the positive electrode active material include a lithium nickel cobalt manganese composite oxide (hereinafter also simply referred to as “LNCM”). The simplest LNCM is expressed by the following general expression: LiNiₓCo_{y}MnZO₂ (in the expression, x, y, and z satisfy 0<x<1,0<y<1,0<z<1, and x+y+z=1). The LNCM may include, in addition to Li, Ni, Co, and Mn, other additive elements, for example, a transition metal element other than Ni, Co, and Mn, and a typical metal element other than Li. The LNCM has a layered crystal structure. The LNCM preferably exceeds 50% by mass of the entire positive electrode active material, and is preferably, for example, 80% by mass to 100% by mass thereof. The positive electrode active material may be configured only of the LNCM. Further, as the positive electrode active material layer, lithium ferrous phosphate (LiFePO₄, LFP), lithium manganese ferro phosphate (LMFP), or the like may be used.

Examples of other positive electrode active materials include a lithium nickel composite oxide, a lithium cobalt composite oxide, and a lithium nickel manganese composite oxide.

Examples of the binder included in the positive electrode mixture layer include vinyl halide resins such as polyvinylidene fluoride (PVdF).

The positive electrode mixture layer may further include other components, for example, an electrically conductive material. Examples of the electrically conductive material include non-graphitizable carbons, graphitizable carbons such as carbon black, and graphite.

### Negative Electrode Mixture Layer

The electrode includes a negative electrode mixture layer.

The negative electrode mixture layer includes a negative electrode active material, and may further include, for example, a binder.

Examples of the negative electrode active material include graphite-based carbon such as natural graphite, artificial graphite, and amorphous coated graphite. The proportion of graphite in the graphite-based carbon is approximately 50% by mass or more, preferably 80% by mass or more.

Examples of the binder included in the negative electrode active material include rubbers such as styrene-butadiene copolymer (SBR) and vinyl halide resins such as polyvinylidene fluoride (PVdF).

The negative electrode mixture layer may further include other components, for example, a thickener and the like. Examples of the thickener include celluloses such as carboxymethylcellulose (CMC).

### Current Collector: Positive Electrode Current Collector and Negative Electrode Current Collector

The electricity storage device according to the embodiment of the present disclosure includes, for example, a plurality of bipolar electrodes each including the negative electrode mixture layer on one surface of a current collector and the positive electrode mixture layer on the other surface of the current collector. The bipolar electrodes are stacked through intermediation of a separator. As the current collector, an electrically conductive member configured of a metal having good conductivity (for example, aluminum, stainless steel (SUS), Ni, Cr, Au, Pt, Fe, Ti, Zn, and the like) is suitable.

### Separator

The separator is an electrically insulating porous film. The separator electrically isolates the positive electrode and the negative electrode. The separator may have a thickness of, for example, 5 μm to 30 μm. The separator may be configured of, for example, a porous polyethylene (PE) membrane, a porous polypropylene (PP) membrane, or the like. The separator may have a multilayer structure. For example, the separator may be configured by laminating a porous PP membrane, a porous PE membrane, and a porous PP membrane in the stated order. The separator may have a heat resistant layer on a surface thereof. The heat resistant layer includes a heat resistant material. Examples of the heat resistant material include metal oxide particles such as alumina, and high-melting point resins such as polyimide.

### Electrolyte

The electricity storage device according to the embodiment of the present disclosure further includes an electrolyte. Examples of the electrolyte include an electrolyte solution, and particularly a non-aqueous electrolyte solution is preferable. In the following, the non-aqueous electrolyte solution is described.
Solvent

The non-aqueous electrolyte solution includes a solvent (non-aqueous solvent) and an electrolyte.

Examples of the solvent (non-aqueous solvent) include N,N-diethyl-N-methyl-N-(2-methoxyethyl)ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).
Electrolyte

Examples of the electrolyte in the electrolyte solution include a Li salt. Examples of the Li salt include lithium bis(fluorosulfonyl)imide (LiFSI), lithium hexafluorophosphate (LiPF6), lithium tetrafluoroborate (LiBF₄), and Li[N(CF₃SO₂)₂].

The amount of the electrolyte may be, for example, 1.0 mol/L to 2.0 mol/L, and is preferably 1.0 mol/L to 1.5 mol/L.

The electrolyte solution may include, in addition to the solvent and the electrolyte, various additives, for example a thickener, a film forming agent, a gas generating agent, and the like. The electrolyte is typically a liquid-state non-aqueous electrolyte solution at room temperature (for example, 25±10° C.). The electrolyte solution typically exhibits a liquid state under the use environment of the battery (for example, under a temperature environment of −20° C. to +60° C.).

### Application

Examples of the application of the electricity storage device according to the embodiment of the present disclosure include a power source of a hybrid electric vehicle (HEV), a plug-in hybrid electric vehicle (PHEV), a battery electric vehicle (BEV), and the like.

What is claimed is:

1. A method of manufacturing an electricity storage device including: an electrode stack including a plurality of bipolar electrodes being stacked through intermediation of a separator; a sealing member that seals a peripheral edge portion of the electrode stack; and
an electrolyte solution accommodated between the bipolar electrodes adjacent in a stacking direction in the electrode stack, the method comprising:
a liquid injecting step of injecting the electrolyte solution into an internal space between the adjacent bipolar electrodes through a liquid injection port of a liquid injection port member including the liquid injection port and a liquid injection port frame, the liquid injection port being provided for injecting the electrolyte solution into the internal space, the liquid injection port frame surrounding the liquid injection port; and
a sealing step of sealing the liquid injection port after the liquid injecting step, by inserting, into the liquid injection port frame of the liquid injection port member, a welding portion of a lid member including the welding portion having a shape along an inner wall of the liquid injection port frame and a support substrate that supports the welding portion, and performing heating from the support substrate side of the lid member such that the welding portion of the lid member and the inner wall of the liquid injection port frame are welded, wherein
the liquid injection port member has the inner wall of the liquid injection port frame configured of a resin L, and a part other than the inner wall of the liquid injection port frame configured of a resin H,
the lid member has at least an outer peripheral surface of the welding portion configured of a resin S, and the support substrate configured of a material M, and
a melting point Tm or a glass transition temperature Tg of each of the resin L, the resin H, and the resin S, and a heating temperature in the sealing step satisfy the following conditions of a, b, and c:
a: the melting point Tm or the glass transition temperature Tg of the resin L is smaller than the melting point Tm or the glass transition temperature Tg of the resin H;
b: the melting point Tm or the glass transition temperature Tg of the resin S is smaller than the melting point Tm or the glass transition temperature Tg of the resin H; and
c: the heating temperature in the sealing step is equal to or larger than the melting point Tm or the glass transition temperature Tg of the resin L, is equal to or larger than the melting point Tm or the glass transition temperature Tg of the resin S, and is smaller than the melting point Tm or the glass transition temperature Tg of the resin H.

2. The method of manufacturing an electricity storage device according to claim 1, wherein the resin H is polypropylene, and the resin L and the resin S are polyethylene.

3. The method of manufacturing an electricity storage device according to claim 1, wherein the welding portion is configured to include a welding portion substrate, and a resin S layer configured of the resin S that covers the welding portion substrate.

4. The method of manufacturing an electricity storage device according to claim 1, wherein the electricity storage device has a rectangular shape as viewed in a thickness direction of the electricity storage device, and the rectangular shape has side lengths of 1,000 mm or more lengthwise and 10,000 mm or more crosswise.

5. An electricity storage device, comprising: an electrode stack including a plurality of bipolar electrodes being stacked through intermediation of a separator; a sealing member that seals a peripheral edge portion of the electrode stack; and an electrolyte solution accommodated between the bipolar electrodes adjacent in a stacking direction in the electrode stack, the electricity storage device further including:
a liquid injection port member including a liquid injection port provided for injecting the electrolyte solution into an internal space between the adjacent bipolar electrodes and a liquid injection port frame that surrounds the liquid injection port; and
a lid member including a welding portion having a shape along an inner wall of the liquid injection port frame and a support substrate that supports the welding portion, the welding portion being welded to the inner wall of the liquid injection port frame, wherein
the liquid injection port member has the inner wall of the liquid injection port frame configured of a resin L, and a part other than the inner wall of the liquid injection port frame configured of a resin H,
the lid member has at least an outer peripheral surface of the welding portion configured of a resin S, and the support substrate configured of a material M, and
a melting point Tm or a glass transition temperature Tg of each of the resin L, the resin H, and the resin S satisfies the following conditions of a and b:
a: the melting point Tm or the glass transition temperature Tg of the resin L is smaller than the melting point Tm or the glass transition temperature Tg of the resin H; and
b: the melting point Tm or the glass transition temperature Tg of the resin S is smaller than the melting point Tm or the glass transition temperature Tg of the resin H.
